(19) United States
(12) Patent Application Publication
(10) Pub. No.: US 2009/0272111 A1
(43) Pub. Date: Nov. 5, 2009

(54) Stirling Engine for Vehicles

(75) Inventors: Makoto Abe, Kanagawa (JP); Yasushi Yamamoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ISUZU MOTORS LIMITED, TOKYO (JP)

(21) Appl. No.: 12/225,715

(22) PCT Filed: Mar. 16, 2007
(86) PCT No.: PCT/JP2007/056129

§ 371 Date: Sep. 29, 2008

(30) Foreign Application Priority Data
Mar. 31, 2006 (JP) 2006-096939

(51) Int. Cl. F02G 1/04

(52) U.S. Cl. 60/522

(57) ABSTRACT

A Stirling engine mounted on a vehicle to efficiently absorb and accumulate the kinetic energy of the vehicle at the time of braking, to improve fuel economy during traveling of the vehicle and to increase the braking effect of an engine brake. The Stirling engine for driving the vehicle is provided with an operating condition-changing device which, at the time of braking the vehicle, changes the operating condition of the Stirling engine over to the heat pump operation. The Stirling engine having, for example, two pistons is provided with the phase difference-changing mechanism 6 for changing a relative phase of the piston 1 and the piston 2. When the brake is applied, the phases of the two pistons are changed to effect the heat pump operation using the power from drive wheels of the vehicle. Heat accumulators 5H and 5C are installed in a heating portion 12 and a cooling portion 22 of the Stirling engine. Braking the vehicle regenerates kinetic energy in heat accumulators as a temperature differential energy which is utilized for the subsequent traveling.

### TECHNICAL FIELD

This invention relates to a heat engine or a so-called Stirling engine which transforms the heat energy possessed by a heat source into the mechanical rotational energy by utilizing an operation fluid sealed in a gaseous state which changes depending upon the heating and cooling. More particularly, the present invention relates to a Stirling engine mounted on a vehicle.

### BACKGROUND ART

The Stirling engine is an external combustion engine having a high theoretical heat efficiency which periodically heats and cools the operation fluid sealed in an operation chamber to change the state, and takes out the rotational energy from a high heat source by utilizing the change in the state. In an internal combustion engine such as a gasoline engine or a diesel engine, a fuel is intermittently burned in the air which is an operation fluid. In the Stirling engine which is an external combustion engine, unlike an internal combustion engine, heat produced by the continuous combustion is transmitted to the operation fluid to heat it offering an advantage in that the state of burning the fuel can be easily controlled producing less harmful exhaust components such as NOx, CO and the like. Not being limited to the heat produced by the combustion, further, this engine makes it possible to utilize various kinds of heat sources such as the exhaust heat of an internal combustion engine, and has excellent features from the standpoint of saving energy and environmental friendliness, too.

Efforts have also been made to develop a technology for making the best use of the Stirling engine, mounting the Stirling engine on a vehicle and for driving the vehicle by using the Stirling engine, and a technology for operating the Stirling engine by using, as a heat source, the exhaust heat from an internal combustion engine that drives the vehicle in order to recover the exhaust heat as the power. Modern engines for vehicles must satisfy strict requirements of decreasing the emission of harmful exhaust gas components and must, further, be capable of saving energy and operating on substitute fuels. The Stirling engine is one of the most expected engines that might be capable of meeting the above requirements.

The Stirling engine is the one that executes the engine cycles by producing the power from the heat of a high heat source and radiating the exhaust heat into a low heat source. Conversely, however, it is also possible to drive the Stirling engine by the external power to execute the heat pump cycles in order to cool the low heat source by sucking the heat from the low heat source. Japanese Unexamined Patent Publication JP-A-8-219569 discloses “a Stirling cycle equipment” which is a combination of a plurality of equipments constituting the Stirling engine and an internal combustion engine, one of the equipments performing the engine cycles to produce power from the exhaust heat of the internal combustion engine while, at the same time, the other equipment executing the cycles of a refrigerator or a heat pump by utilizing the power of the internal combustion engine and the power produced from the exhaust heat.

There are various types of Stirling engines and many of them, generally, have a displacer for periodically moving the operation fluid between the heating space and the cooling space. However, the Stirling cycle equipment disclosed in the above publication uses a Stirling engine of the type having two pistons, i.e., a piston on the compression side and a piston on the expansion side. In equipment that executes the engine cycles and the heat pump cycles, the pistons are coupled together through a planetary gear mechanism so that the phases of the two pistons can be varied. Phases of the pistons are controlled by so adjusting the planetary gear mechanism that their cycles are efficiently executed, respectively, depending upon the load as a refrigerator and the temperature conditions of the exhaust heat of the internal combustion engine.

When the vehicle is to be driven by the Stirling engine, the load exerted on the vehicle varies to a large extent depending upon the traveling conditions of the vehicle, such as the vehicle speed, state of road surface and the like. It is, therefore, desired that the Stirling engine is capable of following the variation of the load in good response. The output of the Stirling engine can be controlled so as to meet the load of the vehicle by a method of controlling the amount of the fuel fed to the heating portion or a method of adjusting the average pressure of the operation fluid. Here, however, the method of controlling the amount of the fuel has a defect from the standpoint of response while the method of controlling the average pressure requires a storage tank for storing the operation fluid resulting in an increase in the weight and size of the engine.

At the time of braking the vehicle that is driven by the engine, further, it is desired that the engine is driven by the wheels so as to brake the vehicle by consuming the kinetic energy of the vehicle, i.e., to apply the engine brake. When the vehicle is traveling downhill, in particular, it is necessary to apply the engine brake to assist braking force of the foot brake and to decrease the burden exerted on the foot brake. The engine brake is to consume the kinetic energy of the vehicle by the engine. Therefore, if the engine is so operated as to transform the kinetic energy into another form of energy, then the engine brake can be realized as a regeneration brake.

The present invention is concerned with a Stirling engine mounted on a vehicle and its problem is to efficiently absorb and accumulate the kinetic energy of the vehicle at the time of applying the brake, to utilize the accumulated energy again at the time of acceleration as well as to increase the braking effect of the engine brake.

### DISCLOSURE OF THE INVENTION

In view of the above problem according to the present invention, the operating condition of the Stirling engine is switched so as to operate as a heat pump at the time of braking the vehicle, so that the kinetic energy of the vehicle is transformed into the so-called “temperature differential energy” and is accumulated. Namely, as described in claim 1, the present invention is concerned with “a Stirling engine mounted on a vehicle to drive the vehicle, comprising a heating portion for heating the operation fluid, a cooling portion for cooling the operation fluid and an operating condition-changing device, the heating portion and the cooling portion having heat accumulators arranged therein, respectively, wherein when the brake of the vehicle is being applied, the operating condition-changing device changes the Stirling engine over to the heat pump operation, so that the temperature of the operation fluid is lowered on the side of the cooling portion to lower the temperature of the heat accumulator of the cooling portion, and that the temperature of the operation fluid is elevated on the side of the heating portion to elevate the temperature of the heat accumulator of the heating portion”.

When the brake of the vehicle is being applied, the Stirling engine of the present invention for driving the vehicle is changed by the operating condition-changing device over to the heat pump operation. That is, when the brake is being applied, the Stirling engine that had been producing the power using the heat from the heating portion in the normal traveling is caused to work as the heat pump through the power transmission system of the vehicle. When the brake is applied, the kinetic energy of the vehicle is consumed within a short period of time and the vehicle speed decreases. Therefore, a very large driving power is produced when the Stirling engine is operated as the heat pump, whereby the temperature of the operation fluid quickly decreases in the cooling portion and the temperature of the operation fluid quickly increases in the heating portion. Heat accumulators are arranged in the heating portion and in the cooling portion of the Stirling engine. The heat pump operation at the time braking is accompanied by an increase in the temperature in the heat accumulator of the heating portion and a decrease in the temperature in the heat accumulator of the cooling portion. As a result, the kinetic energy of the vehicle is regenerated as the temperature differential energy being accumulated in the heat accumulators.

At the time of accelerating the vehicle again after having applied the brake, the Stirling engine is operated as the engine to drive the vehicle by utilizing the temperature differential energy accumulated in the heat accumulators of the heating portion and the cooling portion. At this moment, the temperature of the heating portion has been elevated to be higher than the temperature in the normal state and the temperature of the cooling portion has been lowered. Therefore, the Stirling engine operates in a state of an increased temperature difference between the high heat source and the low heat source, producing an increased output to smoothly accelerate the vehicle. Further, the amount of fuel fed to the heating portion can be greatly decreased contributing to improving the fuel economy.

When traveling the downhill, too, the Stirling engine is changed over to the heat pump operation by the operating condition-changing device. The power required for driving the Stirling engine as the heat pump is very larger than the power which the Stirling engine absorbs when it simply operates as the engine brake. Therefore, a strong braking force acts on the vehicle. Namely, the Stirling engine can be operated as the so-called deceleration device (retarder) decreasing the burden on the foot brake when traveling the downhill. This effect becomes conspicuous particularly with a large and heavy vehicle such as a truck or the like preventing the fading phenomenon that is caused by the overheated braking device. The energy that is regenerated while the heat pump is in operation is transformed into the temperature differential energy, is accumulated in the heat accumulators, and is utilized for the subsequent traveling in the same manner as the one of when applying the brake described above.

As described in claim 2, the Stirling engine can be so constituted as to possess two cylinders filled with the operation fluid and connected with each other, and two pistons reciprocating in the cylinders, the operating condition-changing device varying the relative phases of the two pistons.

There are various types of Stirling engines, such as the one having a displacer and the one without the displacer. With the Stirling engine of the type of the invention having two cylinders filled with the operation fluid and connected with each other and two pistons reciprocating in the cylinders as described in claim 2, the constitution of the operating condition-changing device can be simplified. That is, the output can be adjusted by changing the relative phases of the two pistons and, besides, the operating condition of the Stirling engine can be changed from the engine operation over to the heat pump operation.

To change the Stirling engine over to the heat pump operation, the engine itself may be reversely rotated. That is, as described in claim 3, the operating condition-changing device is arranged on the output shaft of the Stirling engine and when the Stirling engine is to be changed over to the heat pump operation, the Stirling engine is reversely rotated. The method of changing the operating condition by reversely rotating the Stirling engine can be applied to various types of Stirling engines. The operating condition-changing device is desirably a transmission device which is capable of continuously varying the rotational speed of the output shaft relative to the rotational speed of the input shaft and is, further, capable of reversely rotating the shaft (the transmission device of this kind has been disclosed in, for example, JP-A-2001-124166).

### BRIEF DESCRIPTION OF THE DRAWINGS

FIG. 1 is a schematic diagram illustrating a first embodiment of the Stirling engine of the present invention;

FIG. 2 is a view illustrating a phase difference-changing mechanism of the Stirling engine of FIG. 1;

FIG. 3 is a schematic diagram of a control system of the Stirling engine of FIG. 1;

FIG. 4 is a graph illustrating a relationship between the output and the phase of the Stirling engine of FIG. 1; and

FIG. 5 is a schematic diagram illustrating another embodiment of the Stirling engine of the present invention.

### BEST MODE FOR CARRYING OUT THE INVENTION

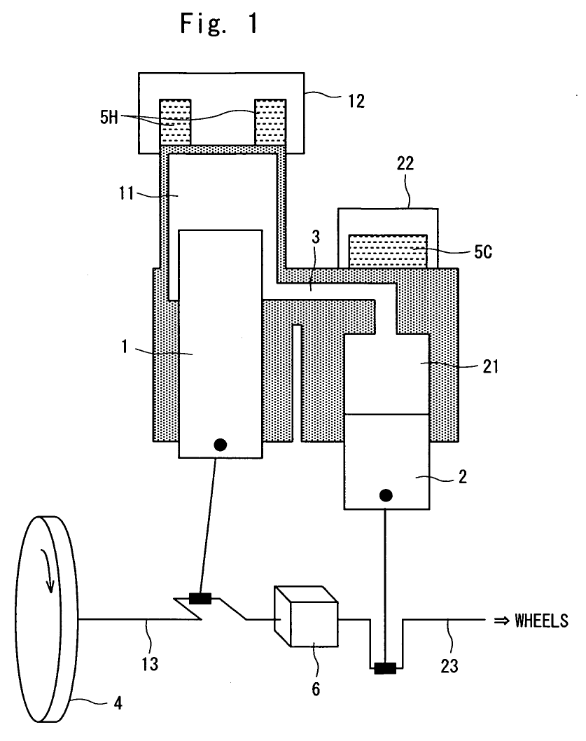

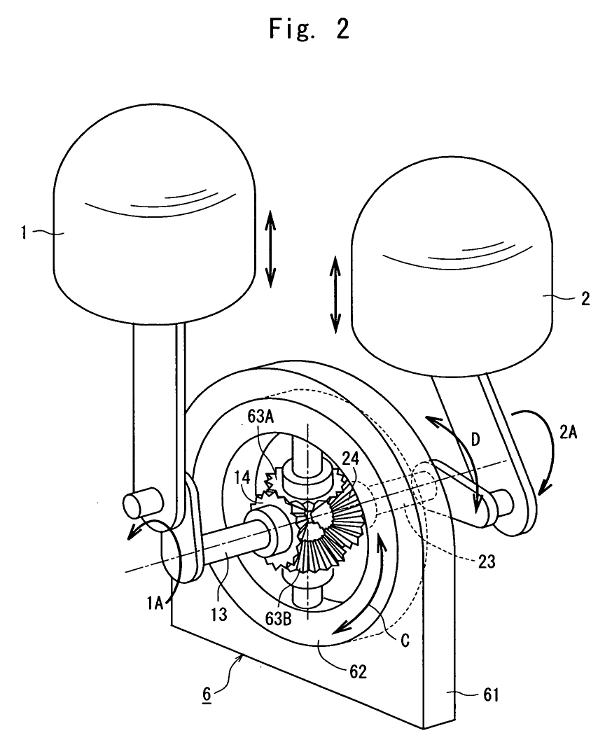

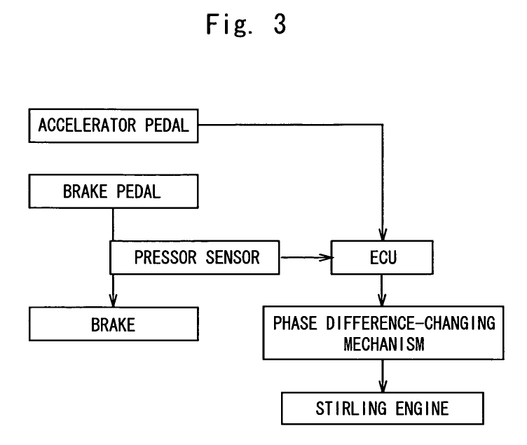

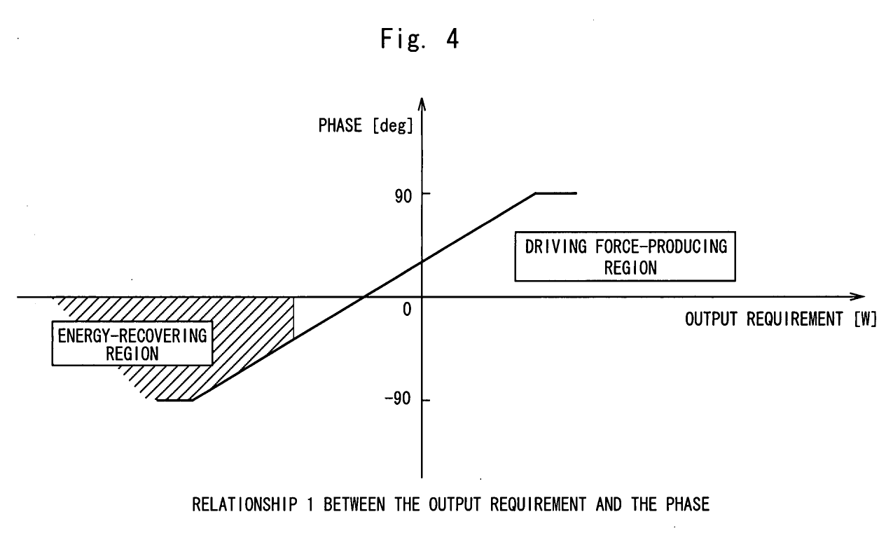

The Stirling engine of the invention will now be described with reference to the drawings. FIG. 1 is a schematic diagram illustrating a first embodiment of the Stirling engine of the invention and FIG. 2 is a view illustrating a phase difference-changing mechanism which is an operating condition-changing device of the Stirling engine of FIG. 1. Further, FIG. 3 is a schematic diagram of a control system for changing the operating condition of the Stirling engine of FIG. 1 and FIG. 4 is a graph illustrating a relationship between the output and the phase of the Stirling engine.

The Stirling engine of the embodiment of FIG. 1 is of the type of an engine equipped with two cylinder/piston mechanisms arranged in parallel, the piston 1 serving as a piston on the expansion side and the piston 2 serving as a piston of the compression side. The cylinder space in the upper part of the piston 1 is a heating space 11, and the cylinder space in the upper part of the piston 2 is a cooling space 21, the heating space 11 and the cooling space 21 being connected with each other via a passage 3. Both spaces 11 and 21 constitute operation chambers of the Stirling engine and contain an operation fluid comprising a gas having a small specific heat, such as hydrogen, helium, etc. A regenerator may be installed in the passage 3 to improve the cycling efficiency by accumulating the heat of the operation fluid that moves between the two spaces 11 and 12.

A heating portion 12 is arranged on the heating space 11 to heat the operation fluid in the heating space 11, and a cooling portion 22 is arranged on the cooling space 21 to cool the operation fluid in the cooling space 21. A fuel is fed from a fuel-feeding device that is not shown into the heating portion 12 and is burned therein. The cooling portion 22 may be of the form of heat-radiating fins for radiating the exhaust heat of the operation fluid into the atmosphere.

The piston 1 is coupled to a crank pin of a crankshaft 13 by a connection rod, and the piston 2 is similarly coupled to a crank shaft 23. The crank shaft 23 is connected to the drive wheels of the vehicle through the power transmission device of the vehicle. When the vehicle is normally traveling, the vehicle is driven by the output of the Stirling engine. A flywheel 4 is fixed to the crankshaft 13.

In the Stirling engine of FIG. 1 of the embodiment of the present invention, heat accumulators 5H are provided in the heating portion 12 and, besides, a heat accumulator 5C is provided in the cooling portion 22, too. These heat accumulators are lumps of a material having a predetermined heat capacity, such as of a metal or ceramics. The crankshaft 13 to which the piston 1 is coupled and the crankshaft 23 to which the piston 2 is coupled, are coupled together via a phase difference-changing mechanism 6 which is the operating condition-changing device, and the phase difference is variable between the piston 1 and the piston 2.

Referring to FIG. 2, the phase difference-changing mechanism 6 is constituted as a gear transmission mechanism resembling a planetary gear device using bevel gears. A through hole is formed in a frame 61 of the phase difference-changing mechanism 6, and an annular ring body 62 is fitted therein so as to rotate. The ring body 62 has two support shafts extending inward in the direction of diameter thereof, and bevel gears 63A and 63B are attached to the support shafts, respectively, so as to rotate. A bevel gear 14 is integrally fixed to the crankshaft 13 of the piston 1, and a bevel gear 24 is integrally fixed to the crankshaft 23 of the piston 2. The bevel gears 14 and 24 are in mesh with the bevel gears 63A and 63B of the support shafts. The four bevel gears are all of the same shape and have the same number of teeth.

When the piston 1 reciprocally moves causing the crankshaft 13 to rotate in the direction of an arrow 1A, the bevel gear 14 causes the bevel gears 63A and 63B of the support shafts to rotate about the support shafts, so that the bevel gear 24 in mesh therewith rotates in the direction opposite to the bevel gear 14 provided the position of the ring body 62 as been fixed. Therefore, the crank shaft 23 of the piston 2 rotates in the direction of an arrow 2A which is opposite to the rotational direction of the crankshaft 13 but at the same speed. Here, if the position of the ring body 62 is moved in the direction of an arrow C, the bevel gears 63A and 63B of the support shafts slightly rotate depending upon the amount of motion thereof, and the phase of the crankshaft 23 can be varied relative to the crankshaft 13. That is, upon adjusting the position of the ring body 62 by using an actuator or the like, the phase difference can be adjusted between the piston 1 and the piston 2 that are reciprocally moving at the same period.

Next, the operation of the Stirling engine of the invention will be described below with reference also to FIGS. 3 and 4.

When the vehicle is normally traveling, the Stirling engine operates as the engine for driving the vehicle. The phase difference between the piston 1 and the piston 2 is set by the phase difference-changing mechanism 6 to be about 90′ which is best suited for the operation of the engine. That is, in a state where the engine is in operation, the phase difference is so set that the volume of the cooling space 21 varies maintaining. a phase delayed by 90′ behind the change in the volume of the heating space 11. The operation fluid in the operation chambers constituted by the heating space 11 and the cooling space 21 undergoes the Stirling cycle repeating the change of state while moving between the two spaces depending upon changes in the volumes of the operation chambers. Therefore, the heat from the heating portion 12 is transformed into the power, and the drive wheels of the vehicle are rotationally driven by the crankshaft 23. To obtain the operation of the engine, the phase difference is decreased to be smaller than 90° as shown in FIG. 4, so that the output of the Stirling engine decreases. Thus, the output of the Stirling engine can be controlled by the phase difference-changing mechanism 6. Adjusting the phase can realize superior response to adjusting the amount of the fuel that is fed to the heating portion 12.

At the time of braking the vehicle, the hydraulic pressure increases in the brake system as the foot brake pedal is depressed. Upon sensing the rise of the hydraulic pressure, the phase difference-changing mechanism 6 changes the phase between the piston 1 and the piston 2, so that the volume of the cooling space 21 varies maintaining a phase 90° ahead of the change in the volume of the heating space 11. Due to this change, the state of the operation fluid changes, i.e., undergoes the so-called inverse Stirling cycle, and the Stirling engine operates as the heat pump. When the brake is applied, the kinetic energy of the vehicle is consumed in a short period of time. Therefore, a large power is fed to the Stirling engine from the drive wheels, whereby the temperature decreases in the cooling space 21 and, at the same time, the temperature increases in the heating space 11. As a result, the accumulators 5H acquire a high temperature in the heating portion 12; i.e., heat energy is accumulated therein. The temperature of the heat accumulator 5C in the cooling portion, on the other hand, decreases and “cold energy” is accumulated therein.

The temperature differential energy accumulated in the heat accumulators at the time of applying the brake of the vehicle is utilized at the time of accelerating the vehicle again. Namely, at the time of acceleration again, the phase difference-changing mechanism 6 is changed over so that the phases of the piston 1 and the piston 2 assume a state of executing the engine cycles. At this moment, the Stirling engine operates due to the temperature differential energy accumulated in the heat accumulators 5H and 5C in the heating portion and in the cooling portion. The temperature difference between the heat accumulator 5H and the heat accumulator 5C is more increasing than that of when usually traveling. Therefore, the Stirling engine produces a large output that meets the acceleration of the vehicle. Further, use of the accumulated temperature differential energy makes it possible to greatly decrease the amount of fuel that is fed to the heating portion.

When the vehicle is traveling downhill, too, the phase difference-changing mechanism 6 changes the Stirling engine over to the heat pump operation. The power for driving the Stirling engine as the heat pump is much larger than the power which the Stirling engine absorbs when it is working as the engine brake. Therefore, a strong braking force acts on the vehicle making it possible to decrease the burden on the foot brake. The energy regenerated as the temperature differential energy while the vehicle is traveling downhill is utilized for the subsequent traveling of the vehicle like the case of when the brake is applied.

FIG. 3 illustrates a control system of when executing the above control. An electronic control unit (ECU) for controlling the phase difference-changing mechanism receives a position signal from the accelerator pedal of the vehicle and a pressure signal from a brake device. When the accelerator pedal is depressed, the ECU so adjusts the position of a ring body of the phase difference-changing mechanism that the Stirling engine operates as the engine, so that the phases of the two pistons are best suited for the engine operation. It is also allowable to so control the phase difference-changing mechanism as to vary the output depending upon the position of the accelerator pedal. Further, the depression of the brake pedal is detected by the pressure sensor in the brake system, and the ECU so changes the position of the phase difference-changing device that the Stirling engine works as the heat pump.

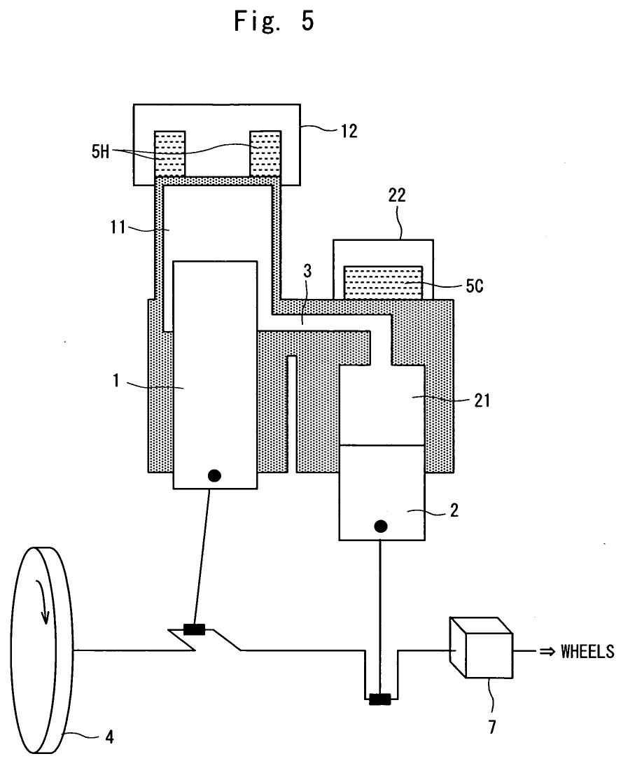

FIG. 5 illustrates another embodiment of the Stirling engine of the present invention in which the engine is reversely rotated to effect the heat pump operation. The basic constitution of devices of the Stirling engine of this embodiment is the same as the one of the embodiment shown in FIG. 1, and the corresponding portions are denoted by the same reference numerals. Here, however, the piston land the piston 2 are coupled to the integral crankshaft, and their phases are fixed to the phases best suited for the engine operation. As the operating condition-changing device, a transmission device 7 which is capable of continuously varying the rotational speed of the output shaft to the rotational speed of the input shaft and also capable of reversely rotating the shaft is installed at the output portion of the crankshaft. To effect the heat pump operation at the time of applying the brake, the Stirling engine is reversely rotated to realize the same operation as that of the embodiment of FIG. 1.

### INDUSTRIAL APPLICABILITY

According to the present invention mounting the Stirling engine on the vehicle as described above in detail, the operating condition of the Stirling engine is changed so as to operate as the heat pump at the time of applying the brake of the vehicle in order to transform the kinetic energy of the vehicle into the temperature differential energy and to accumulate it. Therefore, the invention is applicable to general use when the Stirling engine is mounted as a source of driving the vehicle.

The above embodiments have dealt with the Stirling engine equipped with an expansion piston and a compression piston. However, it will be obvious that the invention can be applied to various types of engines such as the Stirling engine of the type in which the one piston works as a displacer and the another piston works a power piston for taking out the output. Further, it needs not be pointed out that the embodiment can be modified in a variety of ways such as using a phase-changing means of any other mechanism instead of the phase difference-changing mechanism that uses bevel gears.

1. A Stirling engine mounted on a vehicle to drive the vehicle, comprising a heating portion for heating an operation fluid, a cooling portion for cooling the operation fluid and an operating condition-changing device, the heating portion and the cooling portion having heat accumulators arranged therein, respectively, wherein when a brake of the vehicle is being applied, said operating condition-changing device changes the Stirling engine over to a heat pump operation, so that the temperature of the operation fluid is lowered on the side of said cooling portion to lower the temperature of the heat accumulator of said cooling portion, and that the temperature of the operation fluid is elevated on the side of said heating portion to elevate the temperature of the heat accumulator of said heating portion.

2. The Stirling engine according to claim 1, wherein said Stirling engine possesses two cylinders filled with the operation fluid and connected with each other, and two pistons reciprocating in the cylinders, said operating condition-changing device varying a relative phase of the two pistons.

3. The Stirling engine according to claim 1, wherein said operating condition-changing device is arranged on an output shaft of said Stirling engine and when said Stirling engine is to be changed over to the heat pump operation, said Stirling engine is reversely rotated.
